(19) United States
(12) Patent Application Publication
(10) Pub. No.: US 2012/0019867 A1
(43) Pub. Date: Jan. 26, 2012

(54) INDENTIFYING PRINTERS

(76) Inventors: Rodrígo Prati, Porto Alegre (BR); Deny Joao Correa Azzolin, Porto Alegre (BR)

(21) Appl. No.: 13/259,415

(22) PCT Filed: Sep. 14, 2010
(86) PCT No.: PCT/US10/48790

§ 371 Date: Sep. 23, 2011

(30) Foreign Application Priority Data
Feb. 11, 2010 (US) 61303479

(51) Int. Cl. G06F 3/12

(52) U.S. Cl. 358/1.15

(57) ABSTRACT

In some implementations, an indication of a desire to print a file is received. In response, contextual information about multiple different printers is accessed, and measures of perceived appropriateness for printing the file with individual ones of the printers are generated based on the context of the print request and the accessed contextual information about the printers. Thereafter, identifying information for a subset of less than all of the printers and relative indications of the measures of the perceived appropriateness for printing the file with individual printers within the subset of printers are provided.

### CROSS REFERENCE TO RELATED APPLICATION(S)

This application claims priority from U.S. Provisional Patent Application Ser. No. 61/303,479, filed Feb. 11, 2010, and entitled “System and Method for Printing,” which is incorporated herein by reference in its entirety.

### BACKGROUND

A printer is a hardware device that converts files (e.g., documents) into hardcopy form, for example on physical print media such as paper. A printer may be connected to a computer as a local peripheral device. Additionally or alternatively, a printer may have a network interface that enables the printer to be connected to a network (e.g., a local area network (LAN) or a private corporate or enterprise intranet).

Printer drivers may be installed on a computer to coordinate with printers that are accessible to the computer (e.g., as a peripheral or a networked device) to fulfill print requests initiated by the computer. Printer drivers may be specific to particular printer models, such that different printer drivers may be required for each printer model to which the computer is connected and desires to submit print requests.

Conventionally, a computer only may have been able to use a printer to fulfill a print request if the printer was both connected to the computer as a peripheral and/or networked device and the computer was loaded with the appropriate printer driver for the printer.

### SUMMARY

According to one general aspect, an indication of a desire to fulfill a print request and an indication of a context of the print request are received at a first computing system from a mobile computing device. Responsive to receiving the indication of the desire to fulfill the print request, contextual information about multiple different printers is accessed from a printer directory stored in a computer memory storage system. Measures of perceived appropriateness for fulfilling the print request with individual ones of the printers are generated at the first computing system based on the context of the print request and the accessed contextual information about the printers. Identifying information for a subset of less than all of the printers and relative indications of the measures of the perceived appropriateness for fulfilling the print request with individual printers within the subset of printers then are transmitted to the mobile computing device.

Implementations may include one or more of the following features. For example, a selection of a particular one of the printers within the subset of printers as the printer to be used to fulfill the print request may be received from the mobile computing device, and coordination may occur with the selected printer to fulfill the print request at the selected printer.

In some implementations, the mobile computing device may access the Internet over a network provided by a network service provider. As such, the indication of the desire to fulfill the print request and the indication of the context of the print request may be received from the mobile computing device over the network provided by the network service provider and the Internet. In addition, at least a particular one of the printers for which contextual information is stored in the printer directory may reside on a private network that is different than both the network provided by the network service provider and the Internet. As a result, contextual information about at least one printer that resides on a private network that is different than the network provided by the network service provider over which the mobile computing device accesses the Internet may be accessed, measures of the perceived appropriateness for fulfilling the print request with at least one printer that resides on a private network that is different than the network provided by the network service provider over which the mobile computing device accesses the Internet may be generated, and identifying information for and an indication of the perceived appropriateness for fulfilling the print request with at least one printer that resides on a private network that is different than the network provided by the network service provider over which the mobile computing device accesses the Internet may be transmitted to the mobile computing device.

In addition, the mobile computing device may not be configured to submit print requests to at least a particular one of the printers for which contextual information is stored in the printer directory. As such, contextual information about at least one printer to which the mobile computing device is not configured to submit print requests may be accessed, measures of the perceived appropriateness for fulfilling the print request with at least one printer to which the mobile computing device is not configured to submit print requests may be generated, and identifying information for and an indication of the perceived appropriateness for fulfilling the print request with at least one printer to which the mobile computing device is not configured to submit print requests may be transmitted to the mobile computing device.

In some implementations, generating measures of perceived appropriateness for fulfilling the print request with individual ones of the printers based on the context of the print request and the accessed contextual information about the printers may include identifying a particular one of the printers to recommend as being most appropriate for fulfilling the print request based on the generated measures of the perceived appropriateness for printing the file. In such implementations, an indication that the particular printer is recommended as being most appropriate for fulfilling the print request may be transmitted to the mobile computing device.

Furthermore, in such implementations, a new indication of a desire to fulfill another print request and an indication of a context of the other print request may be received at the first computing system from the mobile computing device, and it may be determined that, in connection with at least a threshold number of previously-received indications of desires to fulfill previous print requests received from the mobile computing device, the mobile computing device ultimately selected the printers recommended as being most appropriate for fulfilling the previous print requests. Responsive to receiving the new indication of the desire to fulfill the other print request, contextual information about multiple different printers may be accessed from the printer directory stored in a computer memory storage system, new measures of perceived appropriateness for fulfilling the other print request with individual ones of the printers based on the context of the other print request and the accessed contextual information about the printers may be generated at the first computing system, and a specific printer may be identified from among the printers for which new measures of the perceived appropriateness for fulfilling the other print request were generated to recommend as being most appropriate for fulfilling the other print request based on the generated new measures of the perceived appropriateness for fulfilling the other print request. Identifying information for only the specific printer recommended as being most appropriate for fulfilling the other print request may be transmitted to the mobile computing device as a consequence of having determined that, in connection with at least a threshold number of previously-received indications of desires to fulfill print requests received from the mobile computing device, the mobile computing device ultimately selected the printers recommended as being most appropriate for fulfilling the previous print requests.

In some implementations, receiving an indication of the context of the print request may include receiving an indication of a geographic location of the mobile computing device, and accessing contextual information about multiple different printers from the printer directory may include accessing location information for the different printers. In such implementations, measures of perceived appropriateness for printing the file with individual ones of the printers may be generated based on the received indication of the geographic location of the mobile computing device and the accessed location information for the printers, and transmitting the identifying information for and the relative indications of the measures of the perceived appropriateness for fulfilling the print request with the subset of printers to the mobile computing device may include transmitting indications of the locations of the subset of printers to the mobile computing device.

Furthermore, a group of printers may be identified from among the printers for which measures of the perceived appropriateness for fulfilling the print request were generated as being relatively more appropriate for fulfilling the print request than other of the printers for which measures of the perceived appropriateness for fulfilling the print request were generated based on the generated measures of the perceived appropriateness for fulfilling the print request. In such cases, the group of identified printers may be less than all of the printers, and the identifying information and the relative indications of the measures of the perceived appropriateness for fulfilling the print request with the group of printers may be transmitted to the mobile computing device.

Additionally or alternatively, information about a content type of the file may be received. In such implementations, accessing contextual information about multiple different printers from the printer directory may include accessing one or more of capability information, cost information, and usage information for the different printers, and generating measures of perceived appropriateness for fulfilling the print request with individual ones of the printers based on the context of the print request and the accessed contextual information about the printers may include generating measures of perceived appropriateness for fulfilling the print request with individual ones of the printers based on the content type of the file and one or more of the capability information, cost information, and usage information for the different printers.

According to another general aspect, an indication of a desire to print a file and an indication of a geographic location of a mobile computing device is received from the mobile computing device. In addition, responsive to receiving the indication of the desire to print the file, a printer directory storing identifying information and location information for printers is accessed, a subset of less than all of the printers for which identifying information and location information is stored in the printer directory is identified that includes printers that the mobile device is authorized to use to fulfill print requests, and a measure of perceived appropriateness for printing the file is generated for each of multiple of the subset of printers that the mobile device is authorized to use to fulfill print requests based on the received geographic location of the mobile computing device and the location information for the printer stored in the printer directory. In addition, a subset of less than all of the printers is identified as including printers that are perceived as being relatively more appropriate than other of the printers based on the generated measures of the perceived appropriateness for printing the file. Thereafter, identifying information for the subset of printers perceived as being relatively more appropriate than other of the printers and relative indications of the measures of the perceived appropriateness for printing the file with individual printers within the subset of printers are transmitted to the mobile computing device.

According to yet another general aspect, an indication of a desire to print a file is received via user interaction with a mobile computing device. Responsive to receiving the indication of the desire to print the file, a geographic location of the mobile computing device is determined, and an indication of the desire to print the file and an indication of the geographic location of the mobile computing device is transmitted to a remote computer system over a network connection. Thereafter, identifying information for candidate printers for printing the file and indications of relative measures of appropriateness for printing the file with individual ones of the candidate printers based on the geographic location of the mobile computing device is received from the remote computer system and over the network connection. A display then is caused on the mobile computing device of indications of the candidate printers arranged in an order reflecting the relative measures of appropriateness for printing the file with individual ones of the candidate printers. Responsive to causing the display of the indications of the candidate printers, an indication of a selection of a particular printer, from among the candidate printers, to use to print the file is received via user interaction with the mobile computing device. Responsive to receiving the indication of the selection, a display is caused on the mobile computing device of a message soliciting confirmation from the user that the particular printer is the printer to use to print the file. Responsive to causing the display of the message, an indication of a confirmation to use the particular printer to print the file is received via user interaction with the mobile computing device. Responsive to receiving the indication of the confirmation, a request to use the particular printer to print the file is transmitted to the remote computer system over the network connection.

Implementations may include one or more of the following features. For example, a display may be caused on the mobile computing device of the indications of the candidate printers arranged in a rank order list based on the relative measures of appropriateness for printing the file.

According to still another general aspect, a print signal is received in an application context and a list of available printers sorted according to ranking criteria is transmitted in response to the print signal. In addition, a printer selection signal is received, printer confirmation is requested in response to the printer selection signal, and a print job is transmitted in response to the confirmation.

The various aspects, implementations, and features disclosed may be implemented using, for example, one or more of a method; an apparatus; a system; an apparatus, system, tool, or processing device for performing a method; a computer program or other set of instructions stored on a tangible computer-readable storage medium; and an apparatus that includes a program or a set of instructions stored on a computer-readable storage medium.

### BRIEF DESCRIPTION OF THE DRAWINGS

FIGS. 1A-1G are a sequence of views of an example of a mobile computing device that illustrate one example of a user experience for submitting a print request from a mobile computing device.

FIGS. 2 and 3 are block diagrams of examples of communications networks that enable fulfillment of print requests from mobile computing devices.

FIG. 4 is a flowchart of an example of a process for fulfilling a print request.

FIG. 5 is a flowchart of an example of a process for identifying one or more printers as candidates for fulfilling a print request.

### DETAILED DESCRIPTION

Mobile computing devices (e.g., laptop computers, tablet computers, netbooks, Smartphones, personal digital assistants (PDAs), etc.) have become nearly ubiquitous, and as mobile computing device users move about, access to printable content travels along with them. In contrast to mobile computing devices, printers generally remain as stationary devices that are located in one place for an extended period of time.

As mobile computing device users travel around, they may move in and out of proximity of numerous stationary printers that may be suitable for fulfilling print jobs desired by the mobile computing device users. However, these nearby printers may not be connected to the mobile computing device users' mobile computing devices (e.g., as peripheral or networked devices) and/or the mobile computing device users' mobile computing devices may not be loaded with the appropriate printer drivers and/or other software for sending print requests directly to these nearby printers, especially as the universe of printer alternatives continues to grow more and more heterogeneous. Moreover, the mobile computing device user may not even be aware of the availability of these nearby printers.

However, a hosted printing service that is accessible to a mobile computing device user over a network (e.g., the Internet) and that is configured to coordinate with numerous printers to fulfill print requests received by the hosted printing service may enable a mobile computing device user to fulfill a print request at a printer that otherwise may not be available to the user, for instance because the printer resides on a private network (perhaps behind a firewall) and is not accessible to the user's mobile computing device over a public network connection and/or because the user's mobile computing device is not configured to submit print requests directly to the printer.

For example, a businessperson who is traveling on business may view a file using an e-mail client application executing on a Smartphone and then decide that he/she would like to have a hardcopy of the file for the remainder of his/her trip. However, the businessperson's Smartphone may be blocked from accessing the network on which the printers available at the businessperson's hotel reside and/or the businessperson's Smartphone may not be appropriately configured to submit print requests to the printers available at the businessperson's hotel, for instance because the businessperson's Smartphone lacks the appropriate printer drivers for transmitting print requests to the printers. Nevertheless, the hosted printing service, which may be accessible by the businessperson's Smartphone over the Internet, may be configured to be able to establish connections with the printers available at the businessperson's hotel. As such, the hosted printing service may enable the businessperson to print the file at the businessperson's hotel by submitting a request to print the file from the businessperson's Smartphone over the Internet to the hosted printing service, which in turn relays the printing request to one of the printers available at the businessperson's hotel.

For a mobile computing device user, the task of selecting an appropriate printer to which to print content from the mobile computing device may be challenging depending on the mobile computing device user's location and other contextual factors. Due to the fact that printers tend to be stationary, printers are essentially moving targets for mobile computing device users on the go. As mobile computing device users move about, they may lose reference of or have limited or no knowledge of available printers to which to send print requests from their mobile computing devices. Moreover, mobile computing device users may no longer be connected to a single printer or even to a small and well known set of printers (e.g., as peripheral or networked devices). Instead, the total number of printer options available to a mobile computing device user (e.g., through a hosted printing service such as described above) may be in the range of hundreds, thousands, or even millions of printers.

While access to such a large number of printers may enable mobile computing device users to have print requests fulfilled from and at a variety of different locations, this access also may complicate the print request process, as the mobile computing device users now have to identify appropriate printers for their tasks from amongst myriad different options, only a few of which may be local to the users and/or suitable for printing the content the users desire to print. Techniques are described herein for simplifying the print request process for mobile computing device users.

In one example, a workflow simplifies the process for a mobile computing device user of selecting a printer in a given domain, sending a print request to the selected printer, and locating where to pick up the ultimate printout. This workflow may be referred to colloquially as providing a “three-click” user experience in reference to the three primary inputs received from the mobile computing device user during the print request process.

By way of summary, the first “click” occurs when, after using his/her mobile computing device to locate content (e.g., a file) that the user desires to print, the mobile computing device user selects a “Print” button or other selectable control, for example, from within the application context, on the mobile computing device interface. In response, the context of the print request (e.g., location of the mobile computing device, content type, and/or user preferences) is determined, and a set of available printers perceived as appropriate for fulfilling the print request is identified based, at least in part, on the context of the print request. This set of printers then is displayed by the mobile computing device, for example, listed and sorted according to perceived appropriateness for fulfilling the request. The second “click” occurs when the mobile computing device user selects a printer from the list displayed by the mobile computing device.

In response, the mobile computing device displays a confirmation window with a summary of the print request including, for example, an indication of the content to be printed and target printer details. The third “click” occurs when the mobile computing device user enters input confirming the print request, including the content to be printed and the selected printer at which the content is to be printed. In response, the print request is transmitted to the chosen printer, where it is fulfilled. Thereafter, confirmation of the completion of the print request may be notified back to the mobile computing device user.

In a second example, a variation of the workflow described above may provide what is referred to colloquially as a “two-click” user experience in reference to the two primary inputs received from the mobile computing device user during the print request process. According to this second example, it may be determined that, over time, the mobile computing device user has agreed with and selected the top recommended printer for fulfillment of print requests more than some predefined threshold percentage (e.g., 95%) of the time. Consequently, it may be determined that it is unnecessary to provide the mobile computing device user with a list of printers from among which to choose a particular printer in response to each print request. Instead, only a single printer (e.g., the printer perceived as most appropriate) may be suggested to the mobile computing device user.

In this example, the first “click” occurs, similarly to the previous example, when the mobile computing device user uses the mobile computing device to locate content that the user desires to print and selects a “Print” button or other selectable control. In response, the context of the print request is determined, and the available printer perceived as most appropriate for fulfilling the print request is identified based, at least in part, on the context of the print request. The mobile computing device then displays a confirmation window with a summary of the print request including, for example, an indication of the content to be printed and details about the printer perceived as being most appropriate for fulfilling the print request.

The second “click” then occurs when the mobile computing device user enters input confirming the content to be printed and that the suggested printer should be used to fulfill the print request. In response. the print request is transmitted to the printer, where it is fulfilled. Thereafter, confirmation of the completion of the print request may be notified back to the mobile computing device user.

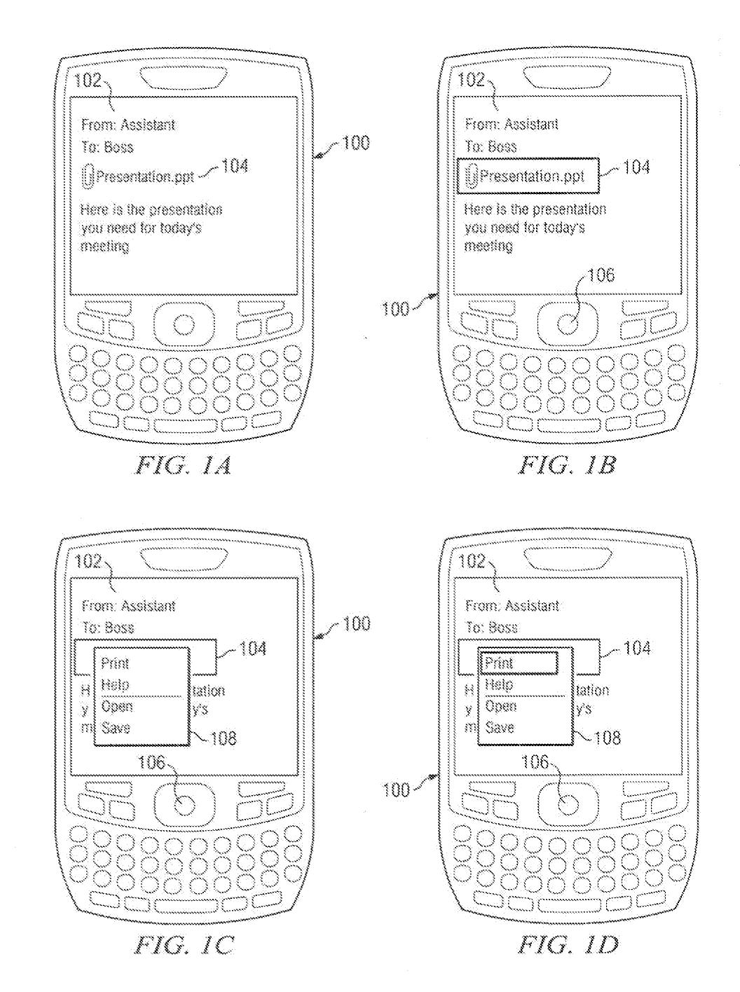

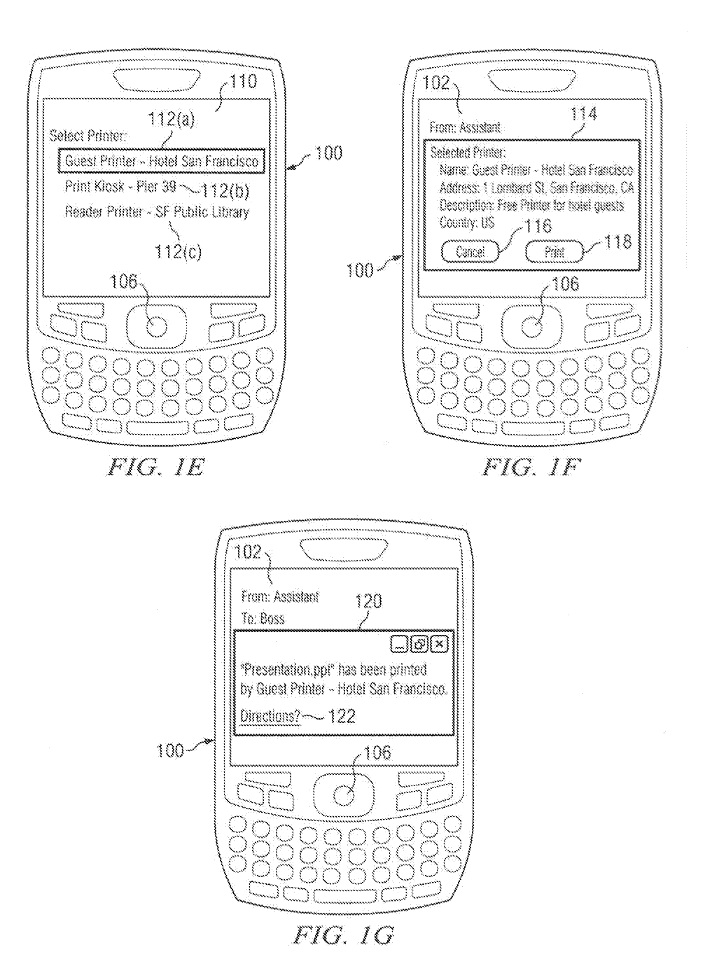

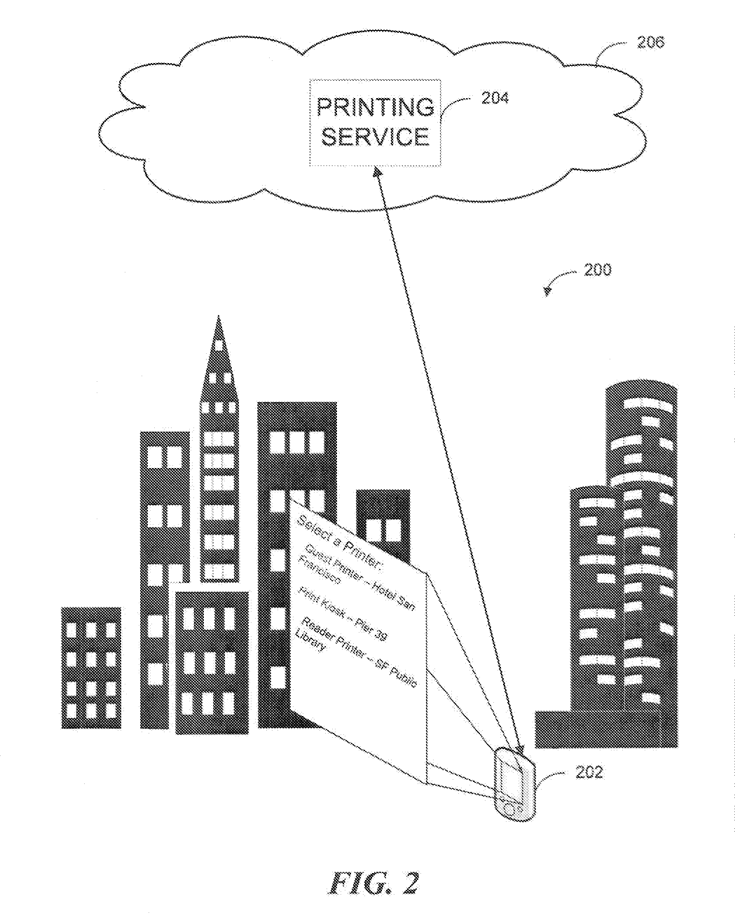

FIGS. 1A-1G are a sequence of views of an example of a mobile computing device 100 that illustrate one example of a user experience for submitting a print request from a mobile computing device. More particularly, FIGS. 1A-1G illustrate one example of a user experience for submitting a print request from a mobile computing device while located in San Francisco, Calif.

As illustrated in FIG. 1A, the mobile computing device 100 is executing an e-mail client application, and the user of the mobile computing device 100 is using the mobile computing device 100 to view an e-mail 102 that includes an attachment 104. Referring now to FIG. 1B, the user of the mobile computing device 100 has used an input mechanism provided by the mobile computing device 100 (e.g., track ball 106) to cause the mobile computing device 100 to highlight the attachment 104 to the e-mail 102 within the e-mail client application.

Thereafter, as illustrated in FIGS. 1C-1D, the user of the mobile computing device 100 has used an input mechanism provided by the mobile computing device 100 to surface a menu 108 within the e-mail client application that provides different options for actions to take in connection with the highlighted attachment 104 and to cause the mobile computing device 100 to select the print option from within the menu 108, thereby indicating a desire to print the attachment 104. This selection of the print option may correspond to the user input referred as the “first click” in connection with the “three click” user experience described above.

In response to the selection of the print option from within menu 108, the context of the print request (e.g., the geographic location of the mobile computing device) is determined, and a number of available printers perceived as being appropriate to use to fulfill the print request based on the context of the print request are identified and displayed on the mobile computing device 100. For instance, in response to the selection of the print option from within menu 108, it may be determined that the mobile computing device 100 is located in San Francisco, Calif. and, as a result, printers located in the San Francisco, Calif. area may be perceived as being appropriate for fulfilling the print request.

For example, referring to FIG. 1E, the mobile computing device 100 may display a select printer window interface 110 that lists the printers identified as being perceived as appropriate for fulfilling the print request. As illustrated, three different candidate printers 112(a)-112(c) are listed in select printer window interface 110, all of which are located in the San Francisco, Calif. area. In some implementations, the printers may be listed in order of perceived appropriateness for fulfilling the print request and/or the printer perceived as being most appropriate for fulfilling the print request may be pre-selected for the user of the mobile computing device 100. For instance, as illustrated in FIG. 1E, the “Guest Printer” at Hotel San Francisco 112(a) was perceived as being most appropriate for fulfilling the print request and, therefore, is pre-selected for the user of the mobile computing device 100.

Referring now to FIG. 1F, the user of the mobile computing device 100 has used an input mechanism provided by the mobile computing device 100 to select the “Guest Printer” at Hotel San Francisco 112(a) from among the printers 112(a)-112(c) listed in the select printer window interface 110. This selection may correspond to the user input referred to as the “second click” in connection with the “three click” user experience described above. In response to the selection of the “Guest Printer” at Hotel San Francisco 112(a), the mobile computing device 100 has displayed a confirmation window 114 with a summary of the print request including details about the selected printer. In addition, the confirmation window 114 also includes a selectable “Cancel” button 116 that enables the mobile computing device user to cancel the print request and a selectable “Print” button 118 that enables the mobile computing device user to confirm the print request.

If the user of the mobile computing device 100 uses an input mechanism provided by the mobile computing device 100 to select the selectable “Print” button 118 from within the confirmation window 114, the mobile computing device 100 initiates the transmission of the print request to the selected printer, where the print request ultimately is fulfilled. This selection of the selectable “Print” button 118 may correspond to the user input referred to as the “third click” in connection with the “three click” user experience described above.

As illustrated in FIG. 1G, in some implementations, after the print request has been fulfilled, a message confirming completion may be transmitted to the mobile computing device 100, and the mobile computing device 100 may display a window 120 confirming that the print request has been fulfilled. In such implementations, the mobile computing device 100 also may display a selectable link 122 (e.g., a hyperlink) that is configured to provide the user of the mobile computing device 100 with access to directions to the printer at which the print request was fulfilled. For example, in response to user selection of selectable link 122, mobile computing device 100 may display a map that indicates a location of the printer at which the print request was fulfilled. Additionally or alternatively, in the case of a GPS-equipped mobile computing device (or any other type of mobile computing device for which it is possible to determine a rough idea of the device's location), the location of the mobile computing device 100 may be determined and directions from the location of the mobile computing device 100 to the location of the printer at which the print request was fulfilled (e.g., turn by turn walking and/or driving directions) may be determined and then displayed on the mobile computing device 100, for example in a textual format and/or visually as an overlay on a map.

FIG. 2 is a block diagram of an example of a communications network 200 that enables fulfillment of print requests from mobile computing devices, such as, for example, mobile computing device 202. Although illustrated as a handheld computing device, such as, for example, a Smartphone or PDA, mobile computing device 202 may be any type of portable computing device including, for example, a laptop, tablet, or netbook computer.

As illustrated in FIG. 2, mobile computing device 202 has access to a hosted printing service 204 over a network 206. In some cases, network 206 may be the Internet, and mobile computing device 202 may access the Internet via a mobile telephony network provided by one or more different network service providers and/or via another wireless network such as, for example, a wireless local area network (WLAN) based on the IEEE 802.11 standard. As a result, mobile computing device 202 may be able to access hosted printing service 204 from numerous different geographic locations in some cases across the globe.

Hosted printing service 204 is configured to coordinate with numerous printers (not shown) to fulfill print requests received by the hosted printing service 204 over network 206 from various different computing devices that have access to hosted printing service 204 over network 206, including portable computing device 202. In this manner, hosted printing service 204 may enable a computing device, such as, for example, mobile computing device 202, to fulfill a print request at a printer that otherwise may not be available to the user, for instance because the printer resides on a private network (perhaps behind a firewall) and is not accessible to the computing device over a public network connection and/or because the computing device is not configured to submit print requests directly to the printer, for instance because the computing device is not loaded with the appropriate printer driver.

The printers with which hosted printing service 204 is configured to coordinate to fulfill print requests may be distributed across various different geographies and even the globe, thereby enabling computing devices that are able to access hosted printing service 204 to have print requests fulfilled at printers in many different locations and even distributed around the world. This fact, combined with the capability of some mobile computing devices to access hosted printing service 204 from various different locations means that it may be possible for a mobile computing device such as, for example, mobile computing device 202, to locate a nearby printer at which to have a print request fulfilled via hosted printing service 204 at various different locations perhaps even around the world.

For example, as illustrated in FIG. 2, when mobile computing device 202 is located in the San Francisco, Calif. area, mobile computing device 202 is able to connect to the Internet over a wireless network (e.g., a mobile telephony network or a WLAN based on the IEEE 802.11 standard), access hosted printing service 204, and locate nearby printers in the San Francisco, Calif. area at which mobile computing device 202 may have print requests fulfilled. Similarly, if mobile computing device 202 were located in the New York City area, mobile computing device 202 may be able to connect to the Internet over a wireless network, access hosted printing service 204, and locate nearby printers in the New York City area at which mobile computing device 202 may have print requests fulfilled.

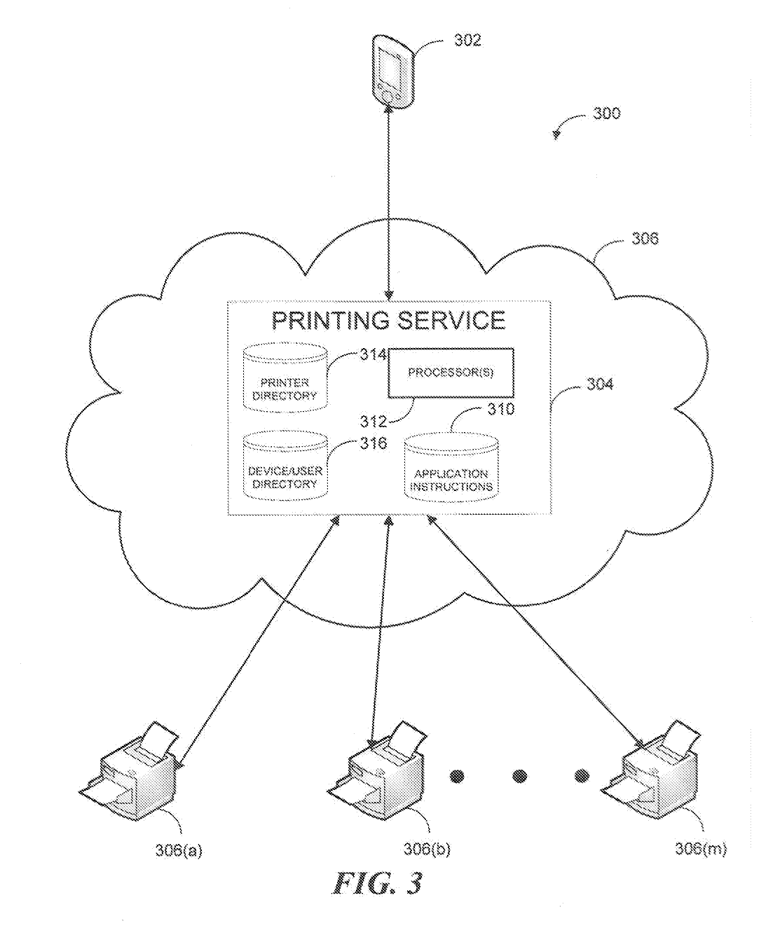

FIG. 3 is another block diagram of an example of a communications network 300 that enables fulfillment of print requests from mobile computing devices, such as, for example, mobile computing device 302. For illustrative purposes, several elements illustrated in FIG. 3 and described below are represented as monolithic entities. However, these elements each may include and/or be implemented on numerous interconnected computing devices and other components that are designed to perform a set of specified operations and that may be dedicated to a particular geographical region or, alternatively, that may be distributed across two or more disparate geographic locations.

As illustrated in FIG. 3, hosted printing service 304 is accessible to mobile computing device 302 and a number of printers 306(a)-306(n) over a network 308. In some implementations, network 308 may be a public network and mobile computing device 302 may reside on or have access to network 308 through one or more corresponding private networks. Similarly, printers 306(a)-306(n) may reside on or have access to network 308 through one or more corresponding private networks. As such, mobile computing device 302 may not be able to access printers 306(a)-306(n) over a public network connection.

Mobile computing device may include one or more general-purpose computers capable of responding to and executing instructions in a defined manner (e.g., personal computers, including laptop, tablet, and netbook computers, Smartphones, and PDAs), one or more special-purpose computers, and/or one or more combinations of general purpose and special-purpose computers.

Mobile computing device 302 typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering standard Internet content and, in some cases, also capable of supporting a web-based e-mail client.

Furthermore, mobile computing device 302 also typically includes a central processing unit (CPU) for executing instructions stored in storage and/or received from one or more other electronic devices, for example over network 308. Mobile computing device 308 also usually includes communication devices for sending and receiving data. One example of such communications devices is a modem. Other examples include antennas, transceivers, communications cards, and other network adapters capable of transmitting and receiving data over network 308 through a wired or wireless data pathway.

Hosted printing service 304 may be implemented using one or more computing devices (e.g., servers) configured to provide a service to one or more client devices (e.g., mobile computing device 302) connected to hosted printing service 304 over network 308. The one or more computing devices on which hosted printing service 304 is implemented may have internal or external storage components storing data and programs such as an operating system and one or more application programs. The one or more application programs may be implemented as instructions that are stored in the storage components and that, when executed, cause the one or more computing devices to provide the features of the hosted printing service described herein.

Furthermore, the one or more computing devices on which hosted printing service 304 is implemented each may include one or more processors for executing instructions stored in storage and/or received from one or more other electronic devices, for example over network 308. In addition, these computing devices also typically include network interfaces and communication devices for sending and receiving data.

Network 308 may provide direct or indirect communication links between hosted printing service 304, mobile computing device 302, and printers 306(a)-306(n) irrespective of physical separation between any of such devices. As such, individual ones of hosted printing service 304, mobile computing device 302, and printers 306(a)-306(n) may be located in close geographic proximity to one another or, alternatively, individual ones of hosted printing service 304, mobile computing device 302, and printers 306(a)-306(n) may be distributed across vast geographic distances. Examples of network 308 include the Internet, the World Wide Web, WANs, LANs, analog or digital wired and wireless telephone networks, radio, television, cable, satellite, and/or any other delivery mechanisms for carrying data.

Hosted printing service 304 is configured to receive print requests from computing devices, such as, for example, mobile computing device 302 and, as appropriate, to identify individual ones of printers 306(a)-306(n) as being appropriate for fulfilling print requests based on the contexts of the received print requests (e.g., the locations of the computing devices when the print requests are issued), inform the requesting computing devices of the printers identified as being, appropriate for fulfilling the print requests, and to relay these print requests to specific ones of printers 306(a)-306(n) selected by the users of the computing devices. In this manner, hosted printing service 304 enables computing devices, such as, for example, mobile computing device 302, to submit and have print requests fulfilled by specific ones of printers 306(a)-306(n) irrespective of whether the computing devices are able to access individuals ones of printers 306(a)-306(n) over a network connection and/or whether the computing devices properly are configured to submit print requests to or otherwise communicate with individual ones of printers 306(a)-306(n).

There may be many reasons why a computing device may be unable to access a particular printer 306 over a network connection. For example, the computing device may be a Smartphone or tablet or netbook computer that has access to the Internet over a wireless connection (e.g., a WLAN based on the IEEE 802.11 standard, a radio frequency-based wireless network, and/or a cellular or mobile telephony network provided by a wireless service provider) made available by a private service provider, and the particular printer 306 to which the user of the computing device wants to print a file may reside on a different private LAN that is connected to the Internet through a firewall (not shown) that blocks incoming communications from unknown or unauthorized devices such as the computing device.

Similarly, there may be many reasons why a computing device may not be configured appropriately to submit a print request to or otherwise communicate with a particular printer 306. For example, the appropriate printer drivers for the computing device may not be installed on the computing device and/or the computing device may not know the correct network address (e.g., IP address) for the printer 306 even if the computing device and the particular printer 306 reside on the same private network.

Hosted printing service 304, computing devices, such as, for example, mobile computing device 302, and printers 306(a)-306(n) may employ various different techniques in order to communicate with each other and to fulfill print requests submitted by the computing devices.

For example, in some implementations, hosted printing service 304 provides an application programming interface (API) that computing devices, such as, for example, mobile computing device 302, and printers 306(a)-306(n) may utilize to communicate with hosted printing service 304 to submit and fulfill print requests. In certain implementations, the API may be a Representational State Transfer (REST) API. The REST framework specifies resources that are referenced by global identifiers (such as uniform resource identifiers or URIs). To manipulate such resources, hosted printing service 304 and printers 306(a)-306(n) may communicate using a standardized interface such as Hypertext Transfer Protocol (HTTP).

The API provided by hosted printing service 304 may include various API routines (or methods) that can be invoked by applications executing at printers 306(a)-306(n) and/or at the hosted printing service 304. Using the REST API may facilitate integration since the API routines can be used to perform communications associated with performing print-related services without having to address conflicts or inconsistencies that may arise due to use of different operating systems in different nodes (e.g., computing devices accessing hosted printing service 304, the computing devices on which hosted printing service 304 is implemented, and/or printers 306(a)-306(n)). Also, using the REST API may make it unnecessary for printer device drivers to be installed on computing devices to enable access to printers 306(a)-306(n) or other print-related services.

Mobile computing device 302 may utilize the REST API in order to submit print requests to hosted printing service 304. Upon receiving a print request from mobile computing device 302, hosted printing service 304 may identify one or more of printers 306(a)-306(n) as being appropriate for fulfilling the print request and, thereafter, transmit identifying information about these printers to mobile computing device 302, for example in an XML stream. Mobile computing device 302 then may select a particular printer as the printer at which to fulfill the print request and transmit this selection to hosted printing service 304. In response, hosted printing service 304 may add the print request to a print request queue corresponding to the particular printer that mobile computing device 302 requested fulfill the print request.

Intermittently (e.g., periodically), individual ones of printers 306(a)-306(n) may utilize the REST API to query hosted printing service 304 to determine whether any print requests are pending for the individual printers at hosted printing service 304. Responsive to such queries, hosted printing service 304 determines whether a print request queue corresponding to a printer from which a query was received includes any pending print requests for the querying printer, and, in response to determining that the queue does include one or more print requests for the printer, hosted printing service 304 transmits, for example using the REST API, the one or more pending print requests for the printer to the printer for fulfillment.

Using the REST API to query hosted printing service 304 for pending print requests and, thereafter, to receive pending print requests from hosted printing service 304 may enable individual ones of printers 306(a)-306(n) to receive print requests from hosted printing service 304 even if the printers 306(a)-306(n) reside on private networks behind firewalls that otherwise would block inbound communications from being relayed to printers 306(a)-306(n).

As illustrated in FIG. 3, hosted printing service 304 includes a computer memory storage system 310 storing application instructions for providing the functionality made available by hosted printing service 304, and one or more processors 312 for executing instructions, for example, from computer memory storage system 310 and/or one or more other electronic devices. As described above, when the application instructions stored in computer memory storage system 310 are executed by processor(s) 312, they cause hosted printing service 304 to receive print requests from one or more remote computing devices, identify appropriate printers for fulfilling these requests based on the contexts of the requests, inform the requesting computing devices of the printers identified as appropriate for fulfilling the requests, and relay the requests to the printers selected by the requesting computing devices for fulfillment.

Hosted printing service 304 also includes a computer memory storage system 314 storing a printer directory and a computer memory storage system 316 storing a device/user directory.

Hosted printing service 304 may perform a printer registration process each time a new printer indicates a desire to make itself available to hosted printing service 304 in order to fulfill print requests received by hosted printing service 304 from computing devices. For example, hosted printing service 304 may expose an API and/or a user interface that enables printers or resources affiliated with such printers (e.g., personal computers having administrator privileges for the printers) to register with hosted printing service 304 such that the printers, thereafter, can collaborate with hosted printing service 304 to fulfill print requests received by hosted printing service 304.

As part of this registration process, when a new printer registers with hosted printing service 304, hosted printing service 304 may collect a variety of information about the new printer including, for instance, a network address (e.g., IP address and/or media access control (MAC) address) for the new printer, a location (e.g., latitude and longitude coordinates, GPS coordinates, street address, building name/number, building floor, floor location, sector, and/or room name, number, or location) of the new printer, capabilities (e.g., formats supported, printing technology (e.g., inkjet or laser), pages per minute, color or black and white, page sizes, resolution) of the new printer, costs to be charged for fulfilling print requests using the printer, protocols for communicating with the new printer, manufacturer and model of the new printer, textual description of the new printer (e.g., a printer name), an owner/operator of the new printer, access rights specifying rules about who is allowed to submit print requests to the new printer, and/or other metadata related to the context of the printer (e.g., names of nearby landmarks or keywords related to the location of the printer). For example, in some cases, printers that register with hosted printing service 304 may be owned or operated by a corporation, and the corporation may restrict access to having print requests fulfilled by printers that the corporation owns or operates only to employees of the corporation. Similarly, in some cases, printers that register with hosted printing service 304 may be owned or operated by a commercial printing business that charges fees for print requests to be fulfilled by the printers that it owns or operates and that restricts access to having print requests fulfilled by printers that it owns or operates only to customers who have accounts with the commercial printing business.

This information gathered by hosted printing service 304 then may be recorded in the printer directory stored in computer memory storage system 314, which records information about the different printers with which hosted printing service 304 is configured to and authorized to collaborate to fulfill print requests received from computing devices. Thus, for each printer with which hosted printing service 304 is configured to and authorized to collaborate, the printer directory stored in computer memory storage system 314 may store a network address, a location, indications of capabilities provided, costs to be charged for fulfilling print requests, information about communication protocols for communicating with the printer, an indication of the manufacturer and model of the printer, a textual description about the printer, an indication of the owner/operator of the printer, rules about who is allowed to submit print requests, and/or other metadata related to the context of the printer. Of course, hosted printing service 304 may provide mechanisms for updating information stored in the printer directory stored in computer memory storage system 314 such that the stored information is not necessarily limited to information gathered during registration but, instead, includes information that may have been updated over time.

Hosted printing service 304 also may perform a device and/or user registration process each time a new computing device and/or new user of a computing device indicates a desire to take advantage of the services provided by hosted printing service 304. For example, hosted printing service 304 may expose an API and/or a user interface that enables computing devices and/or users of computing devices to register with hosted printing service 304 in order to access the services provided by hosted printing service 304.

As part of this user registration process, when a new computing device and/or a new user of a computing device registers with hosted printing service 304, hosted printing service 304 may collect a variety of information about the new computing device and/or the new user including, for instance, a name of the new user, a street address of the new user, authentication information (e.g., a user name or other identifier and a corresponding password, a digital certificate) for the new user and/or device, billing information (e.g., credit card information) for the new user (e.g., in case the user desires to have print requests fulfilled at printers that charge a fee to do so), an indication of printers registered with hosted printing service 304 that the new user and/or device is allowed to access, printer preference information (e.g., information about preferred types and capabilities of printers as well as printers owned by the new user), and/or identifying information for different devices the new user may use to access hosted printing service 304.

This information gathered by hosted printing service 304 then may be recorded in the device/user registry stored in computer memory storage system 316, which records information about the different computing devices and/or users of computing devices that have registered with hosted printing service 304 so as to be able to access the services provided by hosted printing service 304. Of course, hosted printing service 304 may provide mechanisms for updating information stored in the device/user directory stored in computer memory storage system 316 such that the stored information is not necessarily limited to information gathered during device and/or user registration but, instead, includes information that may have been updated over time.

When hosted printing service 304 receives a print request from a computing device, such as, for example, mobile computing device 302, hosted printing service 304 may use information recorded in the printer directory stored in computer memory storage system 314 and/or device/user directory 316 in order to identify printers that are appropriate for fulfilling the print request based on the context of the print request.

Various different processes may be employed by a hosted printing service to fulfill print requests received by the hosted printing service from remote computing devices. In one example, a client application running on a mobile computing device queries and sends requests to a hosted printing service. More particularly, the hosted printing service exposes a printer directory search interface, and the client application running on the mobile computing device queries the hosted printing service through a secure HTTP request, providing parameters that identify the context of the print request, such as, for example, geographic location coordinates of the mobile computing device, keywords related to the context of the print request (e.g., keywords related to a desired location at which to fulfill the print request), and print content qualifiers (content type, size, etc.) among others.

In response, the hosted printing service returns a list of printers that are perceived as appropriate for fulfilling the print request by the hosted printing service in view of the provided parameters. In some implementations, this list may be presented in the form of an XML stream, with printers sorted according to pre-defined order criteria, with the printers perceived as being most relevant to the print request listed before printers being perceived as less relevant to the print request. Relevance heuristics may be defined in terms of, but not limited to, physical proximity, most used printers, content type, keyword matching, print service price, among other configurable parameters.

The list of printers perceived as being appropriate for fulfilling the print request that is returned to the mobile computing device is rendered on the mobile computing device display screen, allowing users to select one of the printers. The user browses the list and selects a particular one of the listed printers to fulfill the print request. As described above, in some implementations, if the user selects the printers ranked as being most relevant enough times to indicate a usage trend, this step may be skipped after a predefined number of print requests.

After the mobile computing device receives an indication of a selection of a printer from the user, the mobile computing device displays a screen with both content and target printer details, prompting the user for confirmation of the content to be printed and the target printer. The user uses an input mechanism provided by the mobile computing device to select a confirmation button rendered within the client application, causing the mobile computing device to send both the content (or a content reference (e.g., a uniform resource identifier (URI))) and a print request to the hosted printing service. The hosted printing service retrieves the content (e.g., from the mobile computing device or from an alternative storage location using the URI for the content) and processes the print request, rendering it and sending it to the printer as a regular print job.

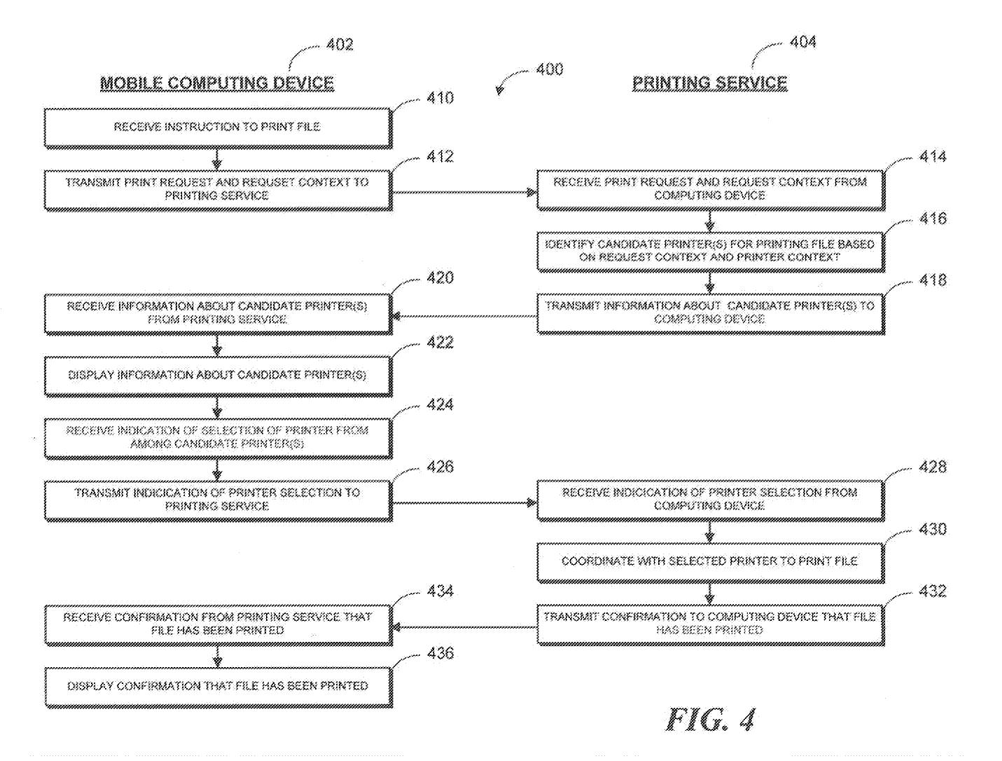

FIG. 4 is a flowchart 400 of an example of a process for fulfilling a print request. The process illustrated in the flowchart 400 of FIG. 4 may be performed by a mobile computing device 402, such as, for example, mobile computing device 100 of FIG. 1, mobile computing device 202 of FIG. 2, or mobile computing device 302 of FIG. 3, in conjunction with a hosted printing service 404, such as, for example, hosted printing service 204 of FIG. 2 or hosted printing service 304 of FIG. 3. In particular, the process illustrated in the flowchart 400 of FIG. 4 may be implemented by one or more processing elements of computing device 402 and one or more processing elements of hosted printing service 404 as a consequence of executing instructions stored on computer-readable storage media accessible to computing device 402 and hosted printing service 404.

At block 410, an instruction to print a file is received at the mobile computing device 402 via user interaction with the mobile computing device. In response, the mobile computing device 402, at block 412, transmits the print request and contextual information about the print request to the hosted printing service 404.

In some implementations, prior to transmitting contextual information about the print request to the hosted printing service 404, the mobile computing device 402 first may have to determine the contextual information about the print request. For example, the mobile computing device 402 may determine the geographic location of the mobile device. In some implementations, the mobile computing device may be a GPS-equipped mobile computing device, and the mobile computing device may determine its geographic location to be its GPS coordinates. In other implementations, when the mobile computing device is connected to a cellular network, the location of the mobile computing device may be determined based on the cells of the network within which the mobile computing device is in range. Additionally or alternatively, the mobile computing device may determine the type of content to be printed, the size (e.g., page numbers) of the content to be printed, the size and/or type of the paper or other tangible medium on which the content is to be printed, etc.

Furthermore, in some implementations, mobile computing device 402 may enable the user to provide one or more keywords associated with the print request to be used to identify appropriate printers for fulfilling the print request. Such keywords may relate to the desired location at which the print request is to be fulfilled, such as, for instance, a geographic location and/or a commercial business name. For example, a businessperson traveling in northern California may be staying at a hotel in San Francisco (e.g., the Hotel San Francisco) but attending meetings in Silicon Valley, just south of San Francisco. In the evening, while returning to San Francisco from Silicon Valley, the businessperson may decide that he/she desires to print a hardcopy of a document that the businessperson received via e-mail on the businessperson's mobile computing device so that he/she can review the document at his/her hotel in San Francisco that night. Therefore, the businessperson's mobile computing device may enable the businessperson to supply one or more keywords related to the print request to help identify an appropriate printer at which to fulfill the print request. For instance, in this case, the businessperson may supply the keywords “Hotel San Francisco” along with the print request in order to indicate that it is desired that the print request be fulfilled by a printer that is close or otherwise convenient to the Hotel San Francisco. In this manner, the hosted printing service may enable users to have print requests fulfilled by printers that are not necessarily within close proximity of the users at the time the print requests are submitted.

Other examples of contextual information about the print request may include identifying information about the user who submitted the print request, identifying information about the mobile computing device 402 that transmitted the print request to the hosted printing service 404, and/or timing information for completing the request (e.g., a deadline by which the print request is to be fulfilled or an indication of the urgency of the print request). Any or all of this contextual information about the print request may be transmitted by the mobile computing device 402 to the hosted printing service 404.

At block 414, the hosted printing service receives the print request and the contextual information about the print request from the mobile computing device 402. In some implementations, in addition to or as an alternative to receiving contextual information about the print request from the mobile computing device 402, the hosted printing service 404 may determine contextual information about the print request.

For example, in some cases, the content to be printed may not ever have been downloaded to the mobile computing device 402 before receiving the request to print the content was received. Instead, the mobile computing device only may have access to a reference (e.g., a URI) to a location at which the content to be printed actually is stored. In such cases, the mobile computing device 402 may not determine certain contextual information about the print request. Instead, the mobile computing device 402 may transmit the reference to the location at which the content to be printed actually is stored to the hosted printing service 404, and the hosted printing service 404 may determine contextual information about the print request including, for example, the type of content to be printed, the size (e.g., page numbers) of the content to be printed, the size and/or type of the paper or other tangible medium on which the content is to be printed, etc.

Additionally or alternatively, hosted printing service 404 may maintain or have access to account and/or preference information associated with the user who submitted the print request and/or the mobile computing device 402 from which the print request was received by the hosted printing service 404. This user- or device-specific information maintained by or accessible to the hosted printing system 404 may specify specific printers to which the user and/or mobile computing device 402 prefers to print files (e.g., printers owned or otherwise associated with the user), types, models, and/or manufacturers of printers to which the user and/or mobile computing device 402 prefers to print files, and/or cost preference information for fulfilling print requests such as costs deemed acceptable for having certain types of print requests fulfilled. Additionally or alternatively, this user- or device-specific information may specify specific printers which the user is authorized/unauthorized to use to fulfill print requests. Similarly, this user- or device-specific information also may specify classes or domains of printers which the user is authorized/unauthorized to use to fulfill print requests.

At block 416, the hosted printing service 404 identifies one or more candidate printers for printing the file based on the contextual information about the print request. In particular, the hosted printing service 404 accesses contextual information about printers accessible through the hosted printing service 404 that are available (e.g., powered on, on-line, and/or operable) to print the file, and uses the contextual information about the printers to identify candidate printers that the hosted printing service 404 perceives as being appropriate for printing the file based on the contextual information about the print request. Contextual information about the printers may include geographic location information, owner/operator information, access right information, usage fee information, status information (e.g., operable or malfunctioning, pending print request queue length, toner level, paper level, etc.), and/or historical usage information. Some or all of the contextual information about the printers may be stored at the hosted printing service 404. Alternatively, the hosted printing service 404 may have to poll individual printers accessible to the hosted printing service 404 in order to determine some of the contextual information about the printers.

In some implementations, the process of identifying candidate printers perceived as being appropriate for printing the file may include calculating measures (e.g., numeric scores) of the appropriateness for printing the file using each of the available printers accessible to the hosted printing service. Alternatively, the process of identifying candidate printers perceived as being appropriate for printing the file may include calculating measures of the appropriateness of printing the file using only some limited subset of the available printers accessible to the hosted printing service. In such implementations, the subset of the available printers for which measures of the appropriateness for printing the file are generated may be identified by filtering all of the accessible and available printers based on contextual information about the print request, including, for example, the geographic location of the mobile computing device 402 and/or printers that the user of the mobile computing device 402 (or the mobile computing device 402 itself) are/are not authorized to use to fulfill print requests.

In implementations in which the hosted printing service 404 generates measures of the appropriateness of printing the file using some or all of the available printers that are accessible to the hosted printing service, the hosted printing service 404 may identify candidate printers perceived as being appropriate for printing the file by selecting some predefined number, “n,” of the printers having the best measures of appropriateness for printing the file (e.g., highest or lowest numeric scores depending on the algorithm used to calculate such numeric scores).

For example, if the only contextual information about the print request is the geographic location of the mobile computing device 402, the hosted printing service 404 may identify the “n” closest, available, and accessible printers to the geographic location of the mobile computing device. Alternatively, if more elaborate contextual information about the print request is available, the hosted printing service 404 may employ a more sophisticated algorithm to identify appropriate printers for printing the file that weights different factors differently in an effort to identify highly appropriate printers for printing the file based on the context of the print request. As one example, if the contextual information about the print request reveals that the print request is urgent, the hosted printing service 404 may identify a first printer that is slightly further away from the location of the mobile computing device 402 than a second printer as being more appropriate for printing the file than the second printer if there is a long queue of pending print requests waiting to be fulfilled by the second printer.

The hosted printing service 404 may rank the candidate printers identified as being appropriate for printing the file based on the perceived appropriateness of each of the identified printers. For example, in implementations where identifying the candidate printers involves generating measures of the appropriateness of available and accessible printers for printing the file, the hosted printing service 404 may rank the candidate printers based on the measures of appropriateness generated for each of the identified candidate printers.

After the hosted printing service 404 has identified the candidate printers perceived as being appropriate for printing the file, at block 418, the hosted printing service 404 transmits information about the candidate printers to the mobile computing device 418. For example, the hosted printing service 404 may transmit identifying information about each of the candidate printers to the mobile computing device 402 to help a user of the mobile computing device 402 to select a suitable one of the candidate printers to fulfill the print request. In addition, the hosted printing service 404 may transmit appropriateness ranking information for the candidate printers and/or other relative measures of the perceived appropriateness of the candidate printers so as to enable the mobile computing device 402 to determine how appropriate the hosted computing service 404 perceives each of the candidate printers to be for printing the file.

At block 420, the mobile computing device 402 receives the information about the candidate printers perceived by the hosted printing service 404 as being appropriate for printing the file from the hosted printing service 404. Then, at block 422, the mobile computing device 402 displays information about the candidate printers to a user of the mobile computing device 402. In some implementations, the mobile computing device 402 displays identifying information about the candidate printers in a manner that reflects the perceived appropriateness of each of the candidate printers as judged by the hosted printing service 404. For example, the mobile computing device 402 may display identifying information about the candidate printers in a rank ordered list in the order of appropriateness as judged by the hosted printing service 404, for instance with the identifying information for the candidate printer perceived as being most appropriate listed first and the identifying information for the candidate printer perceived as least appropriate being listed last.

Moreover, in some implementations, the mobile computing device 402 may display additional information about the candidate printers beyond identifying information. For example, in cases where the hosted printing service 404 generated numeric measures of the appropriateness of each printer, the mobile computing device 402 may display numeric measures of the appropriateness of each candidate printer. Similarly, the mobile computing device 402 also may display an indication of how far away each of the candidate printers is from the current location of the mobile computing device 402. Additionally or alternatively, the mobile computing device 402 may, as appropriate, display information about fees charged to fulfill print requests by each candidate printer (e.g., estimates of anticipated charges to complete the print request) and/or the mobile computing device 402 may display information about the capabilities of each candidate printer.

The information displayed by the mobile computing device 402 may help a user of the mobile computing device 402 determine which of the candidate printers is most appropriate for printing the file. Thus, after the mobile computing device 402 displays the information about the candidate printers at block 422, at block 424, the mobile computing device 402 receives an indication of a selection by a user of the mobile computing device 402 of a printer to print the file from among the candidate printers. Thereafter, at block 426, the mobile computing device 402 transmits the indication of the printer selected by the user to print the file to the hosted printing service 404.

At block 428, the hosted printing service 404 receives the indication of the selected printer from the mobile computing device 402, and, at block 430 the hosted printing service 404 coordinates with the selected printer to have the file printed at the selected printer. In some implementations, as part of coordinating with the selected printer, the hosted printing service 404 will receive a confirmation from the selected printer that the file has been printed after the selected printer has completed the printing of the file. Thus, at block 432, after the file has been printed at the selected printer, the hosted printing service 404 transmits a confirmation to the mobile computing device 402 that the file has been printed.

At block 402, the mobile computing device 434 receives the confirmation from the hosted printing service 404 that the file has been printed and, at block 436, the mobile computing device 402 displays a confirmation message indicating that the file has been printed. In some implementations, as described above in connection with FIG. 1G, this confirmation message may provide the user of the mobile computing device 402 with access to directions to the printer at which the file was printed. In this manner, the user of the mobile computing device 402 may be able to easily identify the location of the printer at which the file was printed for pick up of the printed file even if the user of the mobile computing device 402 is in an unfamiliar location or is not otherwise familiar with the printer that was used to print the file.

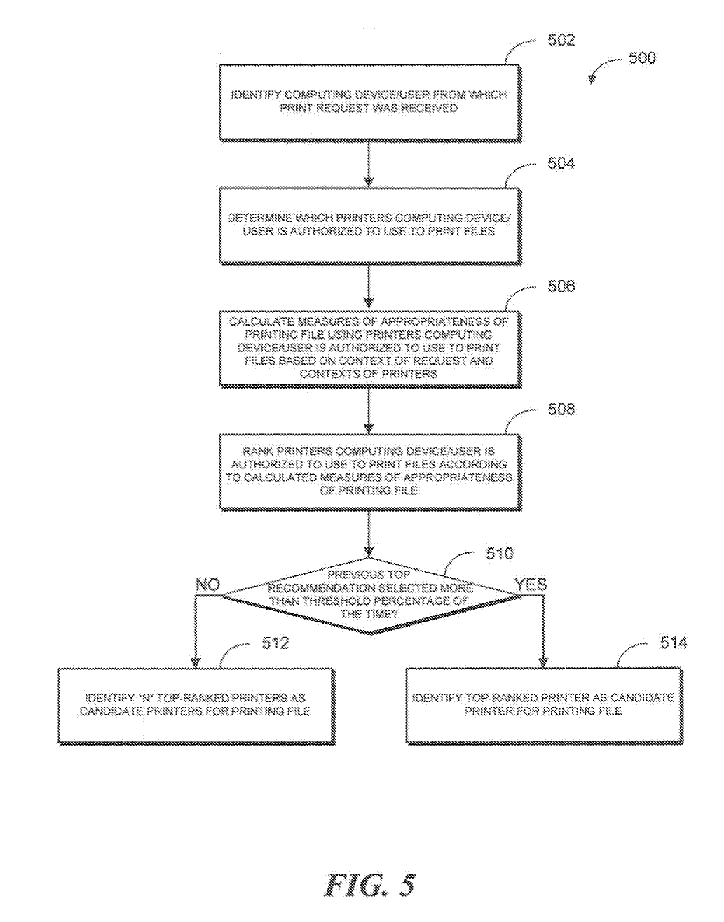

FIG. 5 is a flowchart 500 of an example of a process for identifying one or more printers as candidates for fulfilling a print request. The process illustrated in the flowchart 500 of FIG. 5 may be performed by a hosted printing service, such as, for example, hosted printing service 204 of FIG. 2 or hosted printing service 304 of FIG. 3. In particular, the process illustrated in the flowchart 500 of FIG. 5 may be implemented by one or more processing elements of a hosted printing service as a consequence of executing instructions stored on computer-readable storage media accessible to the hosted printing service. Moreover, the process may be initiated in response to receiving a print request (or an indication of a desire to fulfill a print request) from a mobile computing device, for example, in order to help a user of the mobile computing device select an appropriate printer for fulfilling the print request. This may be useful to the user of the mobile computing device in many cases, for example, when the user of the mobile computing device is in an unfamiliar location and is not familiar with nearby printers and/or when the user of the mobile computing device desires to print content that is of a particular type that the user does not print frequently and, consequently, the user of the mobile computing device is unfamiliar with printers suited for printing content the particular type of content.

At block 502, the hosted printing service identifies the mobile computing device and/or the user of the mobile computing device from which the print request was received. Information identifying the mobile computing device and/or the user of the mobile computing device from which the print request was received may be embedded within the print request. Additionally or alternatively, prior to receiving the print request from the mobile computer device, the hosted printing service may have established an authenticated communications session with the mobile computing device. As part of establishing this authenticated communications session, the mobile computing device may have identified itself to the hosted printing service and/or the user of the mobile computing device may have provided authentication information (e.g., a username or other identifier and password) to the hosted printing service that enables the hosted printing service to identify the user of the mobile computing device from which the print request was received.

At block 504, the hosted printing service determines which printers, from among all of the printers with which the hosted printing service is configured to collaborate to fulfill print requests, the mobile computing device and/or the user of the mobile computing device is authorized to use to fulfill print requests. In some cases, the mobile computing device and/or the user of the mobile computing device only may be authorized to use printers from one or more specific domains to fulfill print requests. For example, the user of the mobile computing device only may be authorized to use printers that reside on a network owned and/or operated by the user's employer or, in some cases, the user of the mobile computing device only may be authorized to use some defined subset of the printers that reside on a network owned and/or operated by the user's employer. Similarly, in some cases, a subset of the printers accessible to the hosted printing service may be owned and/or operated by a commercial printing service, and a user of a mobile computing device only may be authorized to use printers owned/and or operated by the commercial printing service if the user of the mobile computing device has an account with or otherwise has been pre-approved by the commercial printing service.

Information about the access rights of the mobile computing device and/or the user of the mobile computing device from which the print request was received may be available to the hosted printing service from a mobile computing device/user directory, such as, for example, the device/user directory stored in computer memory storage system 316 of FIG. 3. Similarly, information about the domain(s) to which individual printers belong and other information about access rights for individual printers may be available to the hosted printing service from a printer directory, such as, for example, the printer directory stored in computer memory storage system 314 of FIG. 3. By comparing information about the mobile computing device and/or the user of the mobile computing device from which the print request was received that is accessible to the hosted printing service from the device/user directory to information about individual printers accessible to the hosted printing service stored in the printer directory, the hosted printing service may be able to determine which of the printers accessible to the hosted printing service the mobile computing device and/or the user of the mobile computing device is authorized to access.

In some cases, the mobile computing device and/or the user of the mobile computing device from which the print request was received may be authorized to use any of the printers accessible to the hosted printing service to fulfill the print request.

Hosted printing service may use the determination of which printers the mobile computing device and/or the user of the mobile computing device from which the print request was received is authorized to use to fulfill print requests as a filter for narrowing down the number of printers that the hosted printing service considers as part of its effort to identify printers that are appropriate for fulfilling the print request. In some implementations, the hosted printing service may employ one or more additional or alternative filters to narrow down the number of printers that the hosted printing service considers as part of its effort to identify printers that are appropriate for fulfilling the print request. For example, in some implementations, the hosted printing service may limit the printers that it considers as part of its effort to identify printers that are appropriate for fulfilling the print request to printers that are within some predefined distance of the mobile computing device from which the print request was received, to printers that are capable of accommodating the content type of the print request, and/or to printers for which the cost of fulfilling the print request is less than some predefined amount.

In alternative implementations, the hosted printing service may not employ such filters to narrow down the number of printers that the hosted printing service considers as part of its effort to identify printers that are appropriate for fulfilling the print request. In such implementations, the hosted printing service may consider every printer that is accessible to the hosted printing service, but printers that the mobile computing device and/or the user of the mobile computing device is not authorized to use, that are far away from the location of the mobile computing device, that are incapable of (or not well suited for) accommodating the content type of the print request, and/or for which the cost of fulfilling the print request is high may be deemed to be relatively less appropriate for fulfilling the print request than other printers accessible to the hosted printing service.

After identifying which of the printers accessible to the hosted printing service that the mobile computing device and/or the user of the mobile computing device is authorized to use to fulfill print requests, the hosted printing service calculates measures (e.g., numeric scores) of how appropriate each of the printers that the mobile computing device and/or the user of the mobile computing device is authorized to use to fulfill print requests would be for fulfilling this particular print request based on the context of the print request. In calculating these measures of how appropriate each of the printers is for fulfilling the print request based on the context of the print request, the hosted printing service may consider a single factor or the hosted printing service may consider multiple different factors. In implementations in which the hosted printing service considers multiple different factors, each individual factor may be weighted differently to reflect the perceived importance of the factor in determining how appropriate a printer is for fulfilling the print request, and a composite measure of the appropriateness of each printer may be calculated according to the weights assigned to each factor.

The hosted printing service may consider many different types of factors as part of assessing how appropriate individual printers are for fulfilling the print request. Examples of such factors include: location, content type, cost, printer usage, user preferences, and reputation.

Insofar as location is concerned, one aspect of the context of the print request may be the location of the mobile computing device when the print request was sent to the hosted printing service. When location is a factor that is considered as part of the appropriateness calculus, the hosted printing service may consider printers that are relatively near to the location of the mobile computing device to be relatively more appropriate than printers that are relatively far from the location of the mobile computing device.

Moreover, in addition to straight distance, other factors may be considered when using location as a factor in considering how appropriate individual printers are for fulfilling print requests. In such cases, the convenience (or inconvenience) in reaching a printer may be accounted for in addition to straight distance. For example, printers that are on the same floor of a building as the mobile computing device from which the print request was sent may be perceived as being more appropriate than printers that are on different floors of the building from the mobile computing device even if the Euclidean distance between the printers on the different floors and the mobile computing device is less than the Euclidean distance between the printers on the same floor and the mobile computing device.

When location is a factor that is considered as part of the appropriateness calculus, the hosted printing service may receive an indication of the location of the mobile computing device as part of the print request received from the mobile computing device. In some cases (e.g., when the mobile computing device is GPS-equipped), the indication of the location of the mobile computing device may be GPS coordinates or latitude and longitude coordinates determined by the mobile computing device itself prior to sending the print request to the hosted printing service. Additionally or alternatively, the indication of the location of the mobile computing device received by the hosted printing service from the mobile computing device may include a name of a municipality, county, state, country and/or zip code associated with the location from which the mobile computing device transmitted the print request to the hosted printing service. In some implementations, the location of the mobile computing device may be determined based upon the network address (e.g., IP address) of the mobile computing device when the print request was received.

Another factor that the hosted printing service may consider as part of the appropriateness calculus is the type of content that is to be printed. When content type is considered, the hosted printing service may be able to determine the type of the content to be printed by analyzing the content to be printed and/or information about the type of content to be printed may be specified in the print request itself. The hosted computing service then compares the type of content to be printed with the capabilities of the printers accessible to the hosted printing service as part of determining the appropriateness of individual printers for fulfilling the print request. For example, if the content to be printed is mostly raster images, photo printers may be deemed to be more appropriate than black and white laserjet printers. In contrast, if the content to be printed is mostly monochromatic reports such as documents and spreadsheets, black and white laserjet printers may be deemed to be more appropriate than color photo printers. Additionally or alternatively, if the file to be printed is large (e.g., high page count), relatively fast printers may be deemed to be more appropriate than relatively slow printers. Likewise, the size of the paper or other physical medium on which the content is to be printed also may be taken into account. For example, if the content is to be printed on 8.5″ by 11″ letter paper or A4-sized paper, regular home or office-type printers may be deemed more appropriate than large-format printers, whereas, if the content to be printed is better suited for being printed on relatively large paper (e.g., large technical drawings), large-format printers may be deemed to be more appropriate than regular home or office-type printers.

Another factor that may be considered as part of the appropriateness calculus is cost. As discussed above, in some cases, printers that are accessible to the hosted printing service may charge a fee for fulfilling print requests. In such cases, the hosted printing service may determine that relatively low cost (or free) printers are more appropriate than relatively high cost printers.

Usage—be it globally by all users of the hosted printing service or user-specific—is another factor that the hosted printing service may consider as part of the appropriateness calculus. For example, printers that are used relatively frequently by the mobile computing device and/or user of the mobile computing device that submitted the print request may be deemed more appropriate for fulfilling the print request than printers used relatively infrequently by the mobile computing device and/or user of the mobile computing device to fulfill print requests. The rationale may be that the mobile computing device and/or the user of the mobile computing device that submitted the print requests uses those printers that the mobile computing device and/or user of the mobile computing device uses most frequently because the mobile computing device and/or the user of the mobile computing device prefers those printers over other printers and/or because those printers generally are more convenient to the mobile computing device and/or user of the mobile computing device.

Additionally or alternatively, in some implementations, printers that are used relatively frequently by any users may be deemed to be relatively more important than printers that are used relatively infrequently by any users. In such implementations, the rationale may be that frequency of use may be used as a proxy for determining the effectiveness of a printer—with relatively frequently used printers being assumed to be relatively effective printers and relatively infrequently used printers being assumed to be relatively ineffective printers.

Another manner in which printer usage may become involved in the appropriateness calculus relates to the current usage of the printer at the time that the print request is to be fulfilled. For example, all else being equal, the hosted printing service may consider a printer having a relatively short (or empty) queue of currently-pending print requests to be relatively more appropriate than a printer having a relatively long queue of currently-pending print requests, because the printer with the relatively short queue of currently-pending print requests may be able to complete the print request more quickly than the printer having the relatively long queue of pending print requests.

Another example of a factor that the hosted printing service may consider in the appropriateness calculus is preference information of the user of the mobile computing device that submitted the print request. Such preference information may be accessible to the hosted printing service from a mobile computing device/user directory, such as, for example, the device/user directory stored in computer memory storage system 316 of FIG. 3. Examples of how the hosted printing service may account for user preferences in the appropriateness calculus include determining that a user prefers a particular model or brand of printers and deeming printers of that model or brand as being more appropriate than other models or brands of printers; determining that a user prefers to use printers owned/operated by a particular commercial print service over printers owned by other commercial print services and deeming the printers owned/operated by the particular commercial print service as being more appropriate than printers owned/operated by other commercial print services; and/or determining that the user prefers a particular type of printer technology (e.g., inkjet) over another type of printer technology (e.g., laser) and deeming printers of the particular preferred type of printer technology as more appropriate than printers of other types of printing technologies.

Reputation is another example of a factor that the hosted printing service may consider in the appropriateness calculus. For example, the hosted printing service may access indications of other users' satisfaction with various different printers or print services and use these indications to influence its determination of how appropriate individual printers may be for fulfilling the print request. All else being equal, the hosted printing service may consider a printer designated by other users as having a relatively good reputation to be relatively more appropriate than a printer designated by other users as having a relatively poor reputation. In this manner, the hosted printing service may determine that an individual printer or a print service are appropriate for fulfilling the print request even if the individual printer or the print service are relatively new and potentially are unknown to the user.

After calculating measures of the appropriateness of using individual printers to fulfill the print request at block 506, the hosted printing service, at block 508, ranks the printers for which the measures of appropriateness have been calculated based on their measures of appropriateness for fulfilling the print request. For example, in the case where the hosted printing service calculates the appropriateness of individual printers as numeric scores with higher scores representing printers perceived by the hosted printing service to be more appropriate for fulfilling the print request, the hosted printing service may rank the printers from printers having the highest appropriateness scores to printers having the lowest appropriateness scores.

Then, at block 510, the hosted printing service determines whether the that mobile computing device and/or the user of the mobile computing device that sent the request has selected the particular printers that the hosted printing service previously has recommended as being the most appropriate printers for fulfilling previously-received print requests more than some threshold percentage of the time. If not, at block 512, the hosted printing service identifies a predefined number “n” of highly-ranked printers as being candidate printers for fulfilling the print request. In some implementations, the hosted printing service may identify the “n” most highly-ranked printers as the candidate printers for fulfilling the print request. Alternatively, in other implementations, the hosted printing service may filter the printer rankings based on one or more relevancy criteria in order to identify the “n” printers to identify as candidate printers for fulfilling the print request. In such implementations, keywords related to the context of the print request received from the mobile computing device and/or the user of the mobile computing device may be one example of a relevancy criterion used to filter the printer rankings. When keywords are used to filter the printer rankings, the hosted printing service only may consider printers having metadata that matches (either exactly or to within a threshold degree of similarity) the keywords for inclusion within the group of “n” candidate printers for fulfilling the print request. Street addresses, neighborhood or locality names, names of nearby landmarks or venues (e.g., shopping malls, airport, and hotels) are examples of different types of keywords that may be received from mobile computing devices and/or users of mobile computing devices and used to filter printer rankings. Filtering the printer rankings in this manner to identify “n” candidate printers for fulfilling a print request may enable the hosted printing service to provide more precise printer recommendations than otherwise would be possible.

In contrast, if the hosted printing service determines that the mobile computing device and/or the user of the mobile computing device that sent the print request has elected the particular printers that the hosted printing service previously has recommended as being the most appropriate printers for fulfilling previously-received print requests more than some threshold percentage of time, at block 514, the hosted printing service identifies only the most highly ranked printer as a candidate printer for fulfilling the print request. In some implementations, the hosted printing service only may consider previous success in recommending appropriate printers for the mobile computing device and/or the user of the mobile computing device that submitted the request after the hosted printing service has serviced a predefined number of print requests (perhaps during a predefined window of time) on behalf of the mobile computing device and/or the user of the mobile computing device.

A number of methods, techniques, systems, and apparatuses have been described. The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order, in some implementations, individual operations may be rearranged in a different order and/or eliminated and the desired results still may be achieved. Similarly, components in the disclosed systems may be combined in a different manner and/or replaced or supplemented by other components and the desired results still may be achieved.

Moreover, other variations may be possible. For example, in some implementations, when a hosted printing service is identifying candidate printers for fulfilling a print request from a user of a mobile computing device, one or more default printers (e.g., the user's home or office printer(s)) may be included automatically. within the group of printers identified as good candidates for fulfilling the print request irrespective of whether the default printer(s) otherwise would be perceived as being appropriate for fulfilling the print request. Consequently, in such implementations, the user of the mobile computing device may be assured of being able to easily access a printer with which the user is familiar irrespective of the user's current location and other contextual factors associated with the print request.

Furthermore, while the techniques for identifying appropriate printers for fulfilling a print request based on the context of the print request generally are described as being performed by a hosted printing service that is distinct and remote from the requesting computing device, in some implementations, the requesting computing device may perform techniques for identifying appropriate printers for fulfilling the print request based on the context of the print request. In such implementations, after a suitable printer has been selected, the requesting device still may collaborate with a hosted printing service, such as, for example, the hosted printing services described herein, to have the print request fulfilled by the selected device.

Additionally or alternatively, while individual hosted printing services generally are described as both identifying printers appropriate for fulfilling print requests based on the contexts of the print requests and, thereafter, coordinating with a particular one of the identified printers to complete the print requests, in some implementations, two separate hosted services may be involved in the process. For example, a first hosted service may identify appropriate printers for fulfilling a print request for a mobile computing device based on the context of the print request and a second hosted service may coordinate with the mobile computing device and a particular one of the printers identified as being appropriate for fulfilling the print request to complete the print request. In such implementations, the mobile computing device may first collaborate with the first hosted service to identify an appropriate printer for fulfilling a print request. Thereafter, once a printer has been selected to fulfill the print request, the mobile computing device may pass information about the selected printer, perhaps gleaned from the interactions with the first hosted service, on to the second hosted service to enable the second hosted service to collaborate with the selected printer to fulfill the print request.

What is claimed is:

1. A computer-implemented method comprising:
receiving, from a mobile computing device and at a first computing system, an indication of a desire to fulfill a print request and an indication of a context of the print request;
responsive to receiving the indication of the desire to fulfill the print request, accessing, from a printer directory stored in a computer memory storage system, contextual information about multiple different printers;
generating, at the first computing system, measures of perceived appropriateness for fulfilling the print request with individual ones of the printers based on the context of the print request and the accessed contextual information about the printers; and
transmitting, to the mobile computing device, identifying information for a subset of less than all of the printers and relative indications of the measures of the perceived appropriateness for fulfilling the print request with individual printers within the subset of printers.

2. The method of claim 2 further comprising:
responsive to transmitting the identifying information for and the relative indications of the measures of the perceived appropriateness for fulfilling the print request for the subset of printers, receiving, from the mobile computing device, an indication of a selection of a particular one of the printers within the subset of printers as the printer to be used to fulfill the print request; and
coordinating with the selected printer to fulfill the print request at the selected printer.

3. The method of claim 1 wherein:
the mobile computing device accesses the Internet over a network provided by a network service provider such that receiving the indication of the desire to fulfill the print request and the indication of the context of the print request from the mobile computing device comprises receiving the indication of the desire to fulfill the print request and the indication of the context of the print request from the mobile computing device over the network provided by the network service provider and the Internet; and
at least a particular one of the printers for which contextual information is stored in the printer directory resides on a private network that is different than both the network provided by the network service provider and the Internet such that:
accessing contextual information about multiple different printers from the printer directory includes accessing contextual information about at least one printer that resides on a private network that is different than the network provided by the network service provider over which the mobile computing device accesses the Internet,
generating the measures of the perceived appropriateness for fulfilling the print request with individual ones of the printers includes generating the measures of the perceived appropriateness for fulfilling the print request with at least one printer that resides on a private network that is different than the network provided by the network service provider over which the mobile computing device accesses the Internet, and
transmitting identifying information and indications of the perceived appropriateness for fulfilling the print request with the subset of printers to the mobile computing device comprises transmitting identifying information for and an indication of the perceived appropriateness for fulfilling the print request with at least one printer that resides on a private network that is different than the network provided by the network service provider over which the mobile computing device accesses the Internet.

4. The method of claim 1 wherein the mobile computing device is not configured to submit print requests to at least a particular one of the printers for which contextual information is stored in the printer directory such that:
accessing contextual information about multiple different printers from the printer directory includes accessing contextual information about at least one printer to which the mobile computing device is not configured to submit print requests;
generating the measures of the perceived appropriateness for fulfilling the print request with individual ones of the printers includes generating the measures of the perceived appropriateness for fulfilling the print request with at least one printer to which the mobile computing device is not configured to submit print requests; and
transmitting identifying information for and indications of the perceived appropriateness for fulfilling the print request with the subset of printers to the mobile computing device comprises transmitting identifying information for and an indication of the perceived appropriateness for fulfilling the print request with at least one printer to which the mobile computing device is not configured to submit print requests.

5. The method of claim 1 wherein:
generating measures of perceived appropriateness for fulfilling the print request with individual ones of the printers based on the context of the print request and the accessed contextual information about the printers includes identifying, from among the printers for which measures of the perceived appropriateness for fulfilling the print request were generated, a particular one of the printers to recommend as being most appropriate for fulfilling the print request based on the generated measures of the perceived appropriateness for printing the file;
transmitting, to the mobile computing device, identifying information for a subset of less than all of the printers and relative indications of the measures of the perceived appropriateness for fulfilling the print request with individual printers within the subset of printers includes transmitting, to the mobile computing device, an indication that the particular printer is recommended as being most appropriate for fulfilling the print request; and
the method further comprises:
receiving, from the mobile computing device and at the first computing system, a new indication of a desire to fulfill another print request and an indication of a context of the other print request,
determining that, in connection with at least a threshold number of previously-received indications of desires to fulfill previous print requests received from the mobile computing device, the mobile computing device ultimately has selected the printers recommended as being most appropriate for fulfilling the previous print requests,
responsive to receiving the new indication of the desire to fulfill the other print request, accessing, from the printer directory stored in a computer memory storage system, contextual information about multiple different printers,
generating, at the first computing system, new measures of perceived appropriateness for fulfilling the other print request with individual ones of the printers based on the context of the other print request and the accessed contextual information about the printers,
identifying, from among the printers for which new measures of the perceived appropriateness for fulfilling the other print request were generated, a specific printer to recommend as being most appropriate for fulfilling the other print request based on the generated new measures of the perceived appropriateness for fulfilling the other print request, and
transmitting, to the mobile computing device, identifying information for only the specific printer recommended as being most appropriate for fulfilling the other print request as a consequence of having determined that, in connection with at least a threshold number of previously-received indications of desires to fulfill print requests received from the mobile computing device, the mobile computing device ultimately has selected the printers recommended as being most appropriate for fulfilling the previous print requests.

6. The method of claim 1 wherein:
receiving the indication of the context of the print request includes receiving an indication of a geographic location of the mobile computing device;
accessing contextual information about multiple different printers from the printer directory includes accessing location information for the different printers;
generating measures of perceived appropriateness for fulfilling the print request with individual ones of the printers based on the context of the print request and the accessed contextual information about the printers includes generating measures of perceived appropriateness for printing the file with individual ones of the printers based on the received indication of the geographic location of the mobile computing device and the accessed location information for the printers; and
transmitting, to the mobile computing device, the identifying information for and the relative indications of the measures of the perceived appropriateness for fulfilling the print request with the subset of printers includes transmitting, to the mobile computing device, indications of the locations of the subset of printers.

7. The method of claim 6 further comprising identifying, from among the printers for which measures of the perceived appropriateness for fulfilling the print request were generated, a group of printers as being relatively more appropriate for fulfilling the print request than other of the printers for which measures of the perceived appropriateness fulfilling the print request were generated based on the generated measures of the perceived appropriateness for fulfilling the print request, the group being less than all of the printers, wherein transmitting, to the mobile computing device, the identifying information for and the relative indications of the measures of the perceived appropriateness for fulfilling the print request with the subset of printers includes transmitting, to the mobile computing device, the identifying information and the relative indications of the measures of the perceived appropriateness for fulfilling the print request with the group of printers identified as being relatively more appropriate for fulfilling the print request than other of the printers for which measures of the perceived appropriateness for fulfilling the print request were generated.

8. The method of claim 6 wherein:
receiving the indication of the desire to fulfill the print request and the indication of the context of the print request further includes receiving information about a content type of the file;
accessing contextual information about multiple different printers from the printer directory further includes accessing one or more of capability information, cost information, and usage information for the different printers; and
generating measures of perceived appropriateness for fulfilling the print request with individual ones of the printers based on the context of the print request and the accessed contextual information about the printers further includes generating measures of perceived appropriateness for fulfilling the print request with individual ones of the printers based on the content type of the file and one or more of the capability information, cost information, and usage information for the different printers.

9. The method of claim 1 wherein the mobile computing device is a laptop computer such that:
receiving, from a mobile computing device, the indication of the desire to fulfill the print request and the indication of the context of the print request comprises receiving, from a laptop computer, the indication of the desire to fulfill the print request and the indication of the context of the print request; and
transmitting the identifying information and the indications of the perceived appropriateness for fulfilling the print request with the subset of printers to the mobile computing device comprises transmitting the identifying information and the indications of the perceived appropriateness for fulfilling the print request with the subset of printers to the laptop computer.

10. The method of claim 1 wherein the mobile computing device is a Smartphone such that:
receiving, from a mobile computing device, the indication of the desire to fulfill the print request and the indication of the context of the print request comprises receiving, from a Smartphone, the indication of the desire to fulfill the print request and the indication of the context of the print request; and
transmitting the identifying information and the indications of the perceived appropriateness for fulfilling the print request with the subset of printers to the mobile computing device comprises transmitting the identifying information and the indications of the perceived appropriateness for fulfilling the print request with the subset of printers to the Smartphone.

11. The method of claim 1 wherein the mobile computing device is a tablet computer such that:
receiving, from a mobile computing device, the indication of the desire to fulfill the print request and the indication of the context of the print request comprises receiving, from a tablet computer, the indication of the desire to fulfill the print request and the indication of the context of the print request; and
transmitting the identifying information and the indications of the perceived appropriateness for fulfilling the print request with the subset of printers to the mobile computing device comprises transmitting the identifying information and the indications of the perceived appropriateness for fulfilling the print request with the subset of printers to the tablet computer.

12. A computer system comprising:
one or more processing elements; and
a computer memory storage system storing:
a printer directory storing identifying information and location information for multiple different printers; and
instructions that, when executed by the one or more processing elements, cause the computer system to:
receive, from a mobile computing device. an indication of a desire to print a file and an indication of a geographic location of the mobile computing device;
responsive to receiving the indication of the desire to print the file:
access the printer directory,
identify, from among the printers for which identifying information and location information is stored in the printer directory, a subset of less than all of the printers that the mobile device is authorized to use to fulfill print requests,
generate, for each of multiple of the subset of printers that the mobile device is authorized to use to fulfill print requests, a measure of perceived appropriateness for printing the file with the printer based on the received geographic location of the mobile computing device and the location information for the printer stored in the printer directory,
identify, from among the printers for which measures of perceived appropriateness for printing the file were generated and based on the generated measures of the perceived appropriateness for printing the file, a subset of less than all of the printers for which measures of perceived appropriateness for printing the file were generated that are perceived as being relatively more appropriate than other of the printers for which measures of perceived appropriateness for printing the file were generated, and
transmit, to the mobile computing device, identifying information for the subset of printers perceived as being relatively more appropriate than other of the printers for which measures of perceived appropriateness for printing the file were generated and relative indications of the measures of the perceived appropriateness for printing the file with individual printers within the subset of printers perceived as being relatively more appropriate than other of the printers for which measures of perceived appropriateness for printing the file were generated.

13. A computer-readable medium storing instructions that, when executed by a processing element, cause the processing element to:
receive, via user interaction with a mobile computing device, an indication of a desire to print a file;
responsive to receiving the indication of the desire to print the file, determine a geographic location of the mobile computing device;
transmit, to a remote computer system over a network connection, an indication of the desire to print the file and an indication of the geographic location of the mobile computing device;
receive, from the remote computer system and over the network connection, identifying information for candidate printers for printing the file and indications of relative measures of appropriateness for printing the file with individual ones of the candidate printers based on the geographic location of the mobile computing device;
cause a display, on the mobile computing device, of indications of the candidate printers arranged in an order reflecting the relative measures of appropriateness for printing the file with individual ones of the candidate printers;
responsive to causing the display of the indications of the candidate printers, receive, via user interaction with the mobile computing device, an indication of a selection of a particular printer, from among the candidate printers, to use to print the file;
responsive to receiving the indication of the selection, cause a display, on the mobile computing device, of a message soliciting confirmation from the user that the particular printer is the printer to use to print the file;
responsive to causing the display of the message, receive, via user interaction with the mobile computing device, an indication of a confirmation to use the particular printer to print the file; and
responsive to receiving the indication of the confirmation, transmitting, to the remote computer system over the network connection, a request to use the particular printer to print the file.

14. The computer-readable medium of claim 13 wherein:
the instructions that, when executed, cause the processing element to cause a display, on the mobile computing device, of the indications of the candidate printers arranged in an order reflecting the relative measures of appropriateness for printing the file with individual ones of the candidate printers include instructions that, when executed, cause the processing element to cause a display, on the mobile computing device, of the indications of the candidate printers arranged in a rank order list based on the relative measures of appropriateness for printing the file.

15. A method, executed by a computer, for printing, comprising:
receiving a print signal in an application context;
transmitting a list of available printers sorted according to ranking criteria, in response to the print signal;
receiving a printer selection signal;
requesting printer confirmation in response to the printer selection signal; and
transmitting a print job in response to the confirmation.
